(19) United States
(12) Patent Application Publication
(10) Pub. No.: US 2015/0036060 A1
(43) Pub. Date: Feb. 5, 2015

(54) Passenger Delivery System

(71) Applicant: Airgo Design Pte. Ltd., Singapore (SG)

(72) Inventor: Alireza Yaghoubi, Kuala Lumpur (MY)

(73) Assignee: Airgo Design Pte. Ltd., Singapore (SG)

(21) Appl. No.: 13/955,532

(22) Filed: Jul. 31, 2013

(51) Int. Cl. B60N 2/01; B60R 11/02; B64D 11/00; B60N 2/42; B60N 3/00; B60R 5/00; B60N 2/22

(52) U.S. Cl. CPC B60N 2/01; B60R 5/00; B60R 11/02; B60N 2/22; B60N 2/42; B60N 3/002; B64D 11/00
USPC 348/837; 297/354.1; 297/216.1; 297/354.12; 297/147; 297/257; 297/217.3

(57) ABSTRACT

A passenger seat assembly comprising an assembly of seating modules arranged for relative pivotal movement; a membranous mesh fixed about each module for providing support to a passenger in said passenger seat assembly; said mesh comprising a passenger support face and a reaction face on an opposed face of each of said modules; said mesh fixed so as to permit relative movement between the passenger face and reaction face and arranged to redistribute tension between the passenger face and the reaction face.

### FIELD OF THE INVENTION

The invention relates to the delivery of passengers on vehicles such as aircraft, trains, ships/ferries, coaches and the like. In particular, it relates to the ergonomic environment of a passenger space and associated amenity to be maintained within the control of the passenger.

### BACKGROUND

There are particular standards governing the delivery of passengers in vehicles, generally relating to safety. With regard to mass transit vehicles, there are further market forces which require operators to provide a degree of comfort and space to the passengers in order to attract fares consistent with the comfort and space provided. Nevertheless, mass transit systems such as long haul and commuter aircraft, long haul trains and coaches all suffer from diminishing margins based on competition and an expectation of the public to have a high level of comfort at the lowest possible costs.

Accordingly, mass transit operators seek to reduce overall costs and compete on price based upon an industry accepted level of comfort and space. Given passenger seats and amenity are common throughout each of the relevant industries, there is often little differentiation between operators.

There is therefore a gap in the market if improvements can be made in any one, or a combination, of passenger comfort, increased passenger amenity and increased space.

### SUMMARY OF INVENTION

In a first aspect the invention provides a video screen assembly for a passenger seat the assembly comprising: a ceiling mount for mounting the assembly to a ceiling of the cabin; an articulated arm coupling a video screen to the ceiling mount; said articulated arm arranged to retract the screen proximate to the ceiling mount and extend the screen to a viewing position; wherein said screen is mounted to the articulated arm so as to permit rotation about at least one principle axis.

In a second aspect the invention provides a passenger seat assembly comprising: a plurality of seat modules, said seat modules comprising a headrest mounted to one end of a backrest and a seat pedestal to which the backrest is pivotally mounted, said seat pedestal mounted to a floor of the cabin; wherein each of said modules, backrest and seat pedestal comprise a peripheral frame for receiving a passenger seat infill.

In a third aspect the invention provides a food tray assembly for a passenger seat, the assembly comprising: a tray mounted to a selectively extendable support, said support mounted to a floor of a vehicle cabin; said selectively extendable support arranged to move the tray from a retracted position within a cavity in the floor to an extended position for use by a passenger within said passenger seat.

In a fourth aspect the invention provides a passenger seat assembly comprising: an assembly of seating modules arranged for relative pivotal movement; a membranous mesh fixed about each module for providing support to a passenger in said passenger seat assembly; said mesh comprising a passenger support face and a reaction face on an opposed face of each of said modules; said mesh fixed so as to permit relative movement between the passenger face and reaction face and arranged to redistribute tension between the passenger face and the reaction face.

In a fifth aspect the invention provides a passenger space comprising: a graphical user interface for receiving input from a passenger and a passenger seat assembly, said graphical user interface in communication with a drive system coupled to said seat assembly, said seat assembly having a plurality of components arranged to move relative to each other through operation of said drive system; said graphical user interface including a touch screen for displaying a graphical representation of the components of said seat assembly, said drive system arranged to move said components in proportion to movement of the graphical representation of said component.

In the various aspects of the present invention each of the key parameters of space, comfort and passenger amenity are improved over the prior art providing a significant departure from the conventional passenger delivery arrangements on any of the mass transit systems involving aircraft, trains, ships/ferries and coaches.

By providing a video screen assembly in a ceiling mounted arrangement removes the position of a standard utility, being the entertainment system, from impacting upon the pitch of passenger seats (spacing between seats). Thus, for the same seat pitch, an increased level of legroom is provided for the passenger at no additional cost on a per passenger basis to the operator.

Further, by providing an articulated arm upon which the video screen is coupled, the passenger may have an improved amenity by positioning the screen according to the passenger's preference rather than placing the screen in a substantially fixed position in the rear of the forward adjacent passenger seat.

The screen assembly may be lockable such that in either a retracted or fully extended position the screen is immovable until released. Further, the screen may be motorized and so raised and lowered by the passenger on operation of a switch. In a motorized orientation, there may be two or more present positions including any one or a combination of:

(i) a fully retracted position
(ii) a fully extended position representing a course adjustment for the positioning of the screen ready for a fine adjustment by the passenger either manually or in a motorized arrangement;
(iii) in a fractionally retracted position so as to allow the passenger to get up from the seat, receive a meal tray or retrieve a bag from the cabin floor.

It will be noted that for option (iii), each of the three conditions stated may be a single retracted position or three separate preset positions. For instance, retrieving an object from the floor may require only a marginal retraction whereas standing from the passenger seat may require a further retraction with receiving a meal tray being intermediate between these positions.

The ceiling mount may include a recess into which the video screen fits in the retracted position. The ceiling mount for the video screen assembly may mount directly to the ceiling of the cabin. Alternatively, the screen assembly may be mounted to the underside of a storage locker for receiving hand luggage, said underside of the storage locker forming an extended portion of the cabin ceiling.

Further still, the video screen assembly may be formed together with a storage locker wherein the storage locker forms part of the ceiling mount, mounted to the ceiling of the cabin.

In a further aspect of the present invention, the passenger seat assembly comprising the peripheral frame elements into which the passenger support material is placed provides several advantages. In the case of conventional cushions, assembly is enhanced by having the cushions mountable to the frame and incorporating intermediate support members within the cushion itself. This allows for a modular construction of the cushions which also increases the ability to replace damaged or stained cushions by ground crew without excessive delay. Further, the peripheral members also allow for the use of membrane type materials such as a mesh which may span across the members. In this way support is provided through a membrane type tension rather than compression of a cushion. In the case of a mesh, intermediate support members are not required and so the passenger seat assembly according to this embodiment may be considerably lighter than a conventional seat.

In a further embodiment, the peripheral frame members may be tubular. By having tubular members the flexural strength of the members may be increased on increasing the diameter of the tubes without increasing weight. Further, by having tubes with rounded cross-section in the case of the embodiment using mesh, will allow for better load distribution as the mesh goes into tension on movement by the passenger.

Further still, by employing weight saving embodiments to the present invention in order to comply with the 16G seat specification, the reduction in weight means the applied forces through deceleration in a crash scenario are reduced, making compliance with the 16G specification easier. This further allows for a reduced size for the cabin floor mounting of the seat further reducing weight which correspondingly increases fuel economy and overall economic benefit. The consequential benefits, given rising fuel prices, not to mention he introduction of carbon trading schemes and the imposition of carbon tax in many countries represents an advance over the prior art.

In a further aspect of the present invention, there is provided a retractable tray being a floor mounted extendable platform for receiving a meal tray or for allowing the passenger a support to read or conduct business.

As with the video screen assembly, by removing the food tray from the adjacent forward passenger seat and placing it within the floor, passenger space is increased without adjusting seat pitch. It will be noted that whilst this increases passenger amenity, the mass transit operator using this aspect of the present invention or the video screen assembly or both in combination, may seek to maintain present levels of passenger leg room at a reduced seat pitch and so increase the volume of passengers within the cabin. Thus, the operator is free to increase passenger amenity or increase revenue for an accepted level of passenger amenity.

The tray support may be in the form of a single column projecting from the floor. Alternatively, it may be a plurality of columns positioned at the corners of the tray. In a still further embodiment, the support may be edged columns so as to support opposed peripheral edges of the tray.

In projecting the tray from the floor, the extendable support may be telescopic which is driven by a range of different mechanisms. For instance, the projection of the support from the floor may be a worm screw, pneumatic system, electric or hydraulic. The support may automatically fully project up to the required height. Alternatively, the food tray may be released so as to project a small distance upwards so as to allow the passenger to lift the tray manually into position.

Once in the full height, the tray may lock in position so as to require the passenger to release the lock before retracting the tray into the floor. Alternatively, the mechanism such as the screw, pneumatic system etc., may hold the tray in position and so requiring the mechanism to reverse before being able to retract the tray.

The tray may have a cover mounted thereto. Alternatively, on retraction into a cavity or recess in the floor, a cover may be manually or automatically placed over the tray. Such a tray cover may be part of the floor and merely slide across in order to close off the recess into which the tray has retracted.

The tray may be mounted to the support in a fixed relation. Alternatively, the tray may be slideable along a first axis such as away from or towards the passenger. The tray may further be slideable along an axis transverse to the passenger. A transverse sliding may, for instance, allow the passenger to stand up without disturbing the contents of the tray.

The mounting of the tray to the support may further include a pivot about the transverse axis so as to permit the passenger who may be using the tray to conduct business to tilt the tray so as to provide a more ergonomic angle for writing or viewing a laptop screen.

In a further aspect of the present invention, the invention may provide a membranous mesh as an alternative to conventional seat cushions for the passenger seat. Such a mesh may have a double layer having a passenger support face and a reaction face on an opposed side of the passenger seat.

The reaction face is arranged to achieve a number of results including the distribution of tension from movement of the passenger so as to maintain a require tension within the membrane so as to support the passenger. Further, the reaction face may provide a dampening effect to dampen vibration caused by the mass transit vehicle.

The reaction face may be of the same material and orientation as the passenger face mesh. Alternatively, the reaction face may be of a different material. In the case of dampening, a more appropriate dampening material may be used such as, for instance, a visco-elastic material which may be designed to prevent unpleasant vibration being transmitted through the passenger seat to the passenger.

Further, the reaction face may not be a membranous face but instead may be a series of discreet elements arranged to span the reverse side of the passenger seat so as to reduce cost or to more effectively balance the distribution of load through the passenger face to the reaction face.

The connection of the mesh to the passenger seat may be through a side coupling. Such a side coupling may permit movement between the passenger face and reaction face for the redistribution of load. This movement may be confined to a first dimension such as backward and forward. The connection may also provide movement along the frame of the passenger seat along the axis of the seat backrest to avoid bunching of material and maintain the membranous tension within the passenger face.

Connection between the mesh and the frame may be through a dedicated elongate eyelet about a stud fixed to the frame. Alternatively, the eyelet may be elliptical shape so as to provide a backward and forward movement along a major axis of the ellipse and a more limited movement along the axis of the backrest.

In a further aspect of the present invention, control of passenger amenity may be provided through an interactive graphical user interface. The graphical user interface includes a touch screen, such as a capacitive touch screen. The passenger amenity may include any one or a combination of position of the passenger seat, movement of the food tray and movement of the video screen.

The graphical user interface may further include communication systems such as a network based communication system including a global network, WAN or a LAN. Such an interface may provide access to a cloud computing system in order to connect with a remote office.

The graphical representation shown on the graphical user interface may include a schematic view of the passenger seat. The passenger may engage portions of the schematic and using a touch based movement reposition the component of the passenger seats to a desired position. The graphical user interface may also include one or more preset positions such as for landing and take-off in a fully upright position or a fully extended position in order to sleep. By having individual control on the graphical user interface, the passenger may visually position each module to precisely the angle and position or extend the module to meet the passenger's needs. This varies from a mere motorized button condition whereby the passenger is unable to see precisely the position of the module. The preset condition may include a customized preset which may be available to the passenger based upon a loyalty program with the mass transit operator. For instance, airlines will often offer frequent travelers preferred seats within the aircraft. This may extend to offering preset conditions on the graphical user interface meeting the requirements of the passenger who may program the preset conditions on the aircraft or through normal online interaction as a member of the loyalty program.

Further, regular passengers may select preferences themselves, such as to a mobile device which, through a software application, may generate a bar code or QR code, which may be read by or through the graphical user interface and automatically add a tab for a customized preferences.

As mentioned, the graphical user interface may include operation of the video screen which may be a video screen assembly according to a further aspect of the present invention. Further, it may include operation of the tray which may be according to the further aspect of the present invention of the extendable tray assembly.

In a still further embodiment, the graphical user interface may be overridden by the mass transit operator. For instance, during landing and take-off the graphical user interface may be disabled so as to ensure all seats are in the upright position. Further, if a particular orientation of the seat, such as leaning forward, is more appropriate during an emergency situation (for instance in “crash position”) the graphical user interface may be overridden by the operator to ensure the seat fits into a preset position consistent with the emergency situation.

The combination of the various aspects of the present invention, either in total or select aspects, represent a passenger space having distinct advantage over the prior art. In addition to this passenger space, a sensor arrangement detecting the presence, movement or inactivity of the passenger may also be included. Such a sensor may be in communication with a control system that instructs the operation of any or a combination of the: video screen assembly, food tray assembly or passenger assembly.

For instance, the sensor may detect the passenger rising from his seat, and consequently instruct the video screen to retract and/or lower the tray assembly. Similarly, the sensor may detect the passenger returning to the seat and so re-position the video screen and/or tray.

In a further embodiment, the sensor may include face detection, or facial movement, whereby on detecting the passenger's eyes being closed for a pre-determined amount of time, for instance 5 minutes, the video screen may be disabled and/or retracted.

The sensor may be a movement detector and/or a proximity detector, and so suited for those embodiments where the passenger's movement determines the action taken. Alternatively, the sensor may be any one of a number of standard commercially available machine vision systems used for the identification of objects using automated image analysis. The characteristic shape of the passenger's body or face may be sufficient for the machine vision system. The sensor may include a camera, which may be a 3 dimensional camera in order to identify the passenger's body through depth perception also. Which category of camera used will be at the discretion of the operator when designing a system falling within the scope of the present invention.

It will be appreciated that the invention may also be applicable for non-transport applications where the person must spend long periods seated, such as:
i) Training where the candidate is required to interact with a digital communication;
ii) Use in a laboratory, where a researcher may be required to observe, for instance, a microscope for extended periods;
iii) Waiting areas in order to distract or educate during the waiting period;
iv) Remote pilots, such as for drone aircraft.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A to 1G are various views of a video screen assembly according to one embodiment of the present invention;

FIGS. 2A, 2C, 2G and 2H are various views of a passenger seat assembly according to one embodiment of the present invention;

FIGS. 2B, 2E, 2F and 2I to 2O are various components of a passenger seat assembly according to a further embodiment of the present invention;

FIGS. 3A to 3H are various views of a retractable tray assembly according to a further embodiment of the present invention;

FIGS. 4A to 4C are various views of a passenger seat assembly according to a further embodiment of the present invention;

FIG. 5A is an isometric view of a passenger space according to one embodiment of the present invention, and;

FIGS. 5B to 5I are various views of a graphical user interface according to one embodiment of the present invention.

### DETAILED DESCRIPTION

The various aspects of the present invention, separately or in combination, provide a passenger space which maximizes passenger amenity vehicle. Said vehicle may be for the transport of multiple passengers, such as a mass transit vehicle, or may be for one or a small number of passengers, such as for a car, space vehicle, limousine or possibly military vehicles. Whilst each of the aspects have distinct advantages, cumulatively or in various combinations, the synergistic effect provides a more efficient space in which the passenger may travel or work whilst increasing passenger space, passenger comfort and/or passenger connectivity.

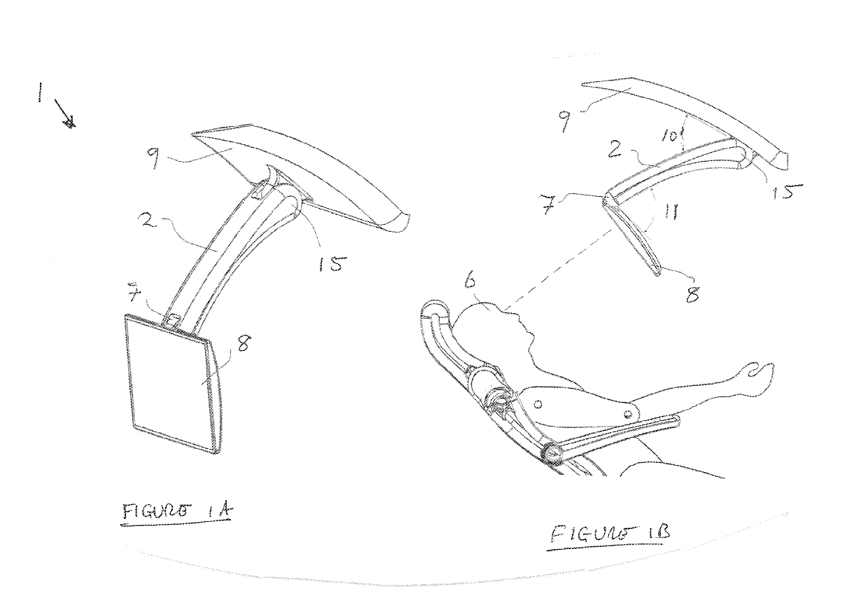

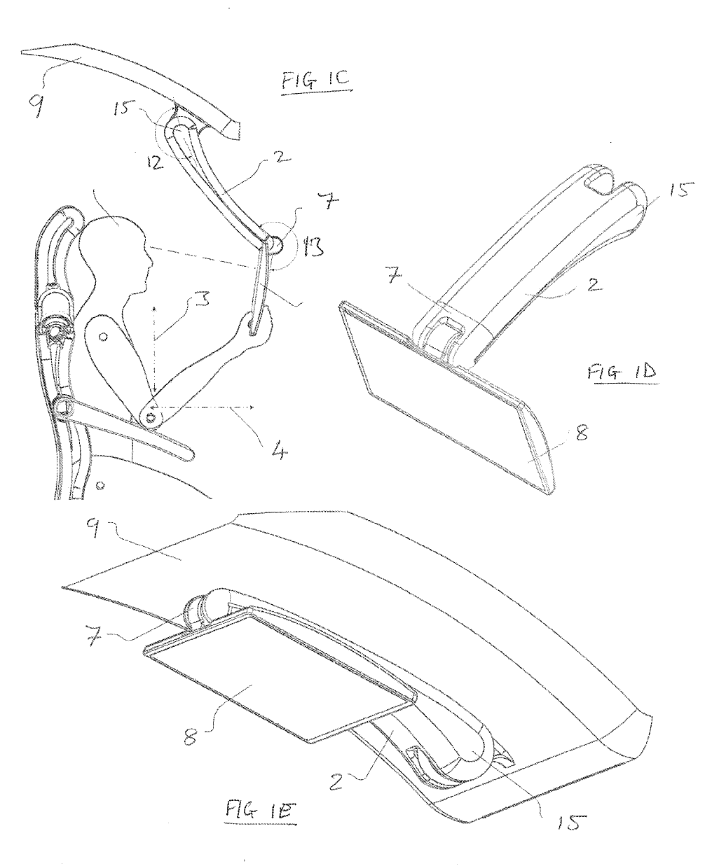

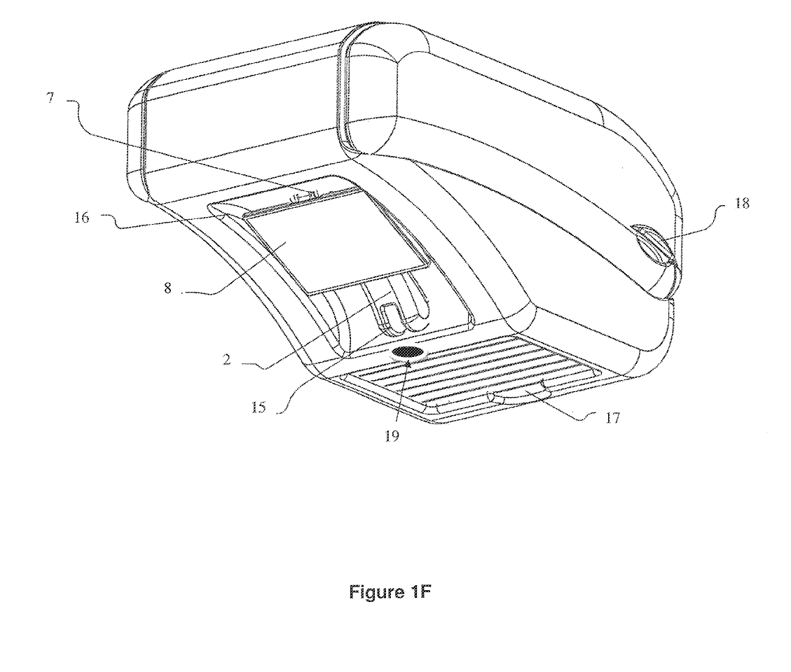

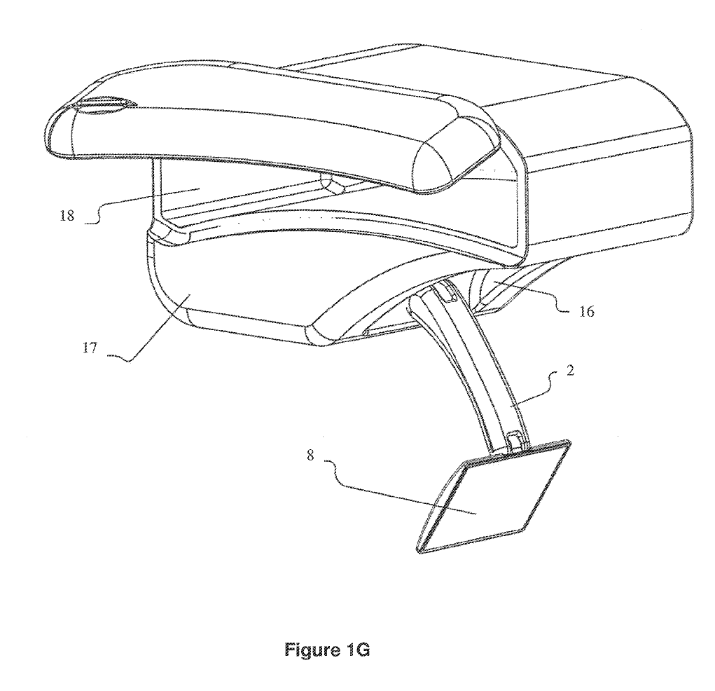

FIGS. 1A to 1E show a video screen assembly 1 according to one embodiment of the present invention. The video screen assembly includes a ceiling mount 9 for mounting to the ceiling of a cabin of the vehicle. The ceiling mount 9 may be bolted to the ceiling or may be part of a modular structure for integration with other modules in the construction of the cabin. Projecting from the ceiling mount 9 is an articulated arm 2 which is pivotally connected 15 to the ceiling mount 9 and able to pivot downwards 10 from the mount. At an opposed end of the articulated arm 2 is a video screen 8 pivotally connected 7 to the articulated arm. The articulation of the arm allows for various positions of the video screen relative to the passenger 6 as shown in FIG. 1B.

The video screen can then retract upward as shown in FIG. 1E, folding the articulated arm 2 proximate to the ceiling mount 9. In a further embodiment shown in FIGS. 1F and 1G, the ceiling mount may include a recess 16 into which the video screen 8 moves from an extended position (FIG. 1G) to a retracted position (FIG. 1G) within the recess 16 so as to provide a flush surface on the ceiling mount.

FIGS. 1F and 1G provide a further embodiment wherein the ceiling mount includes a locker 18 into which cabin luggage may be stowed. The ceiling mount may further include a selectively operable lid and housing 17 to allow the distribution of face masks during emergency events. Thus, the ceiling mount is adaptable in various embodiments to comply with standard civil aviation regulations, whilst still achieving the advantages of the present invention. The locker 18 further includes a sensor 19, arranged to detect movement of the passenger. The sensor 19 is in communication with the drive system, signaling the drive system to retract the video screen on detecting the passenger standing, or turn off the screen on detecting the passenger's eyes having closed. In the latter embodiment, the sensor may include a camera capable of face detection and able to track the movement of the passenger's head so as to confirm the period for which the passenger's eyes are closed.

As mentioned, various positions of the video screen are possible, such as when the passenger seat is reclining as shown in FIG. 1B or in an upright position 5 as shown in FIG. 1C. The articulated arm 2 may provide a coarse adjustment to present the screen proximate to the passenger allowing the passenger as shown in FIG. 1C to provide a fine adjustment of the video screen 8 for the preferred position. Whilst the articulated arm 2 may be rotated through a coarse adjustment, the fine adjustment by the passenger may be through manipulation of the screen 8.

A further advantage of the video screen assembly according to this embodiment is the ability to provide the video screen in an ergonomically beneficial position. FIG. 1C shows how a fine adjustment of the screen is permitted through a mere flexing 3, 4 of the arm of the passenger 5 whilst in contact with the armrest.

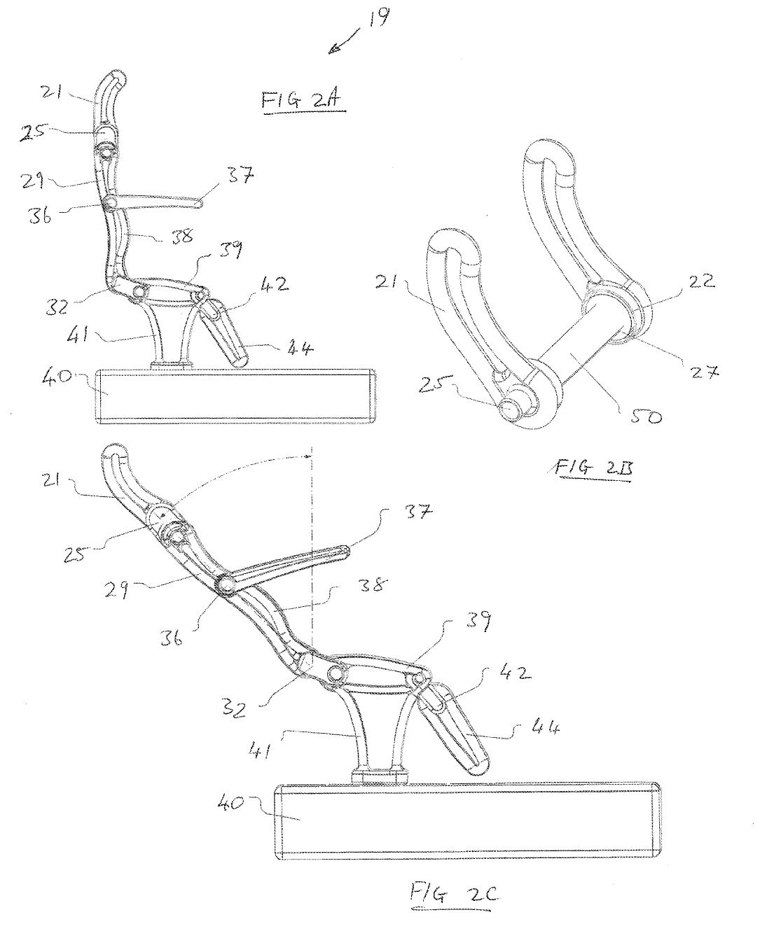

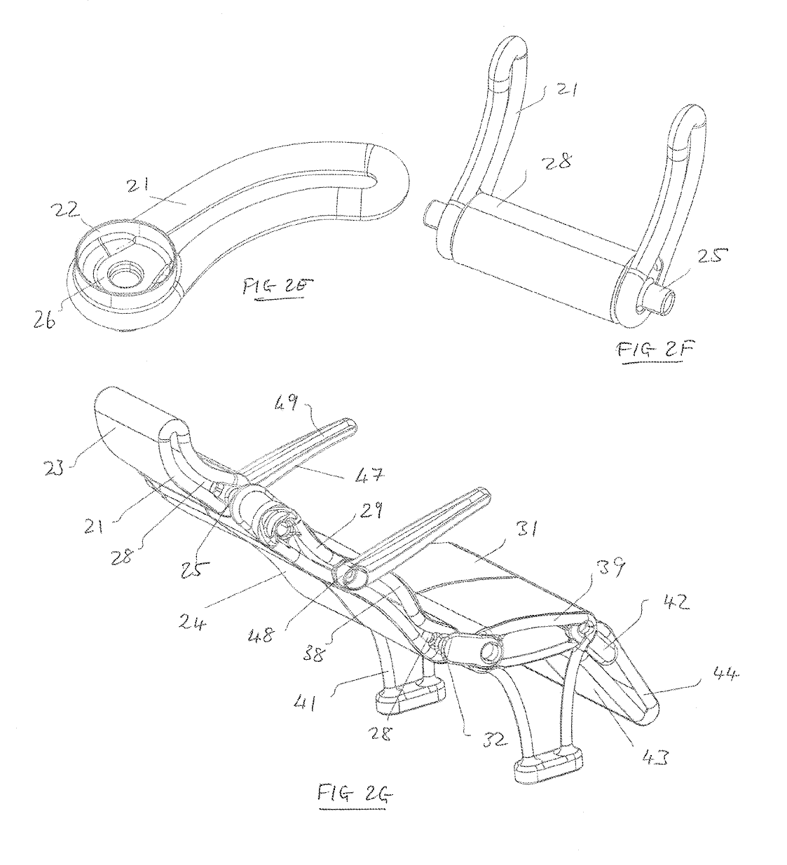

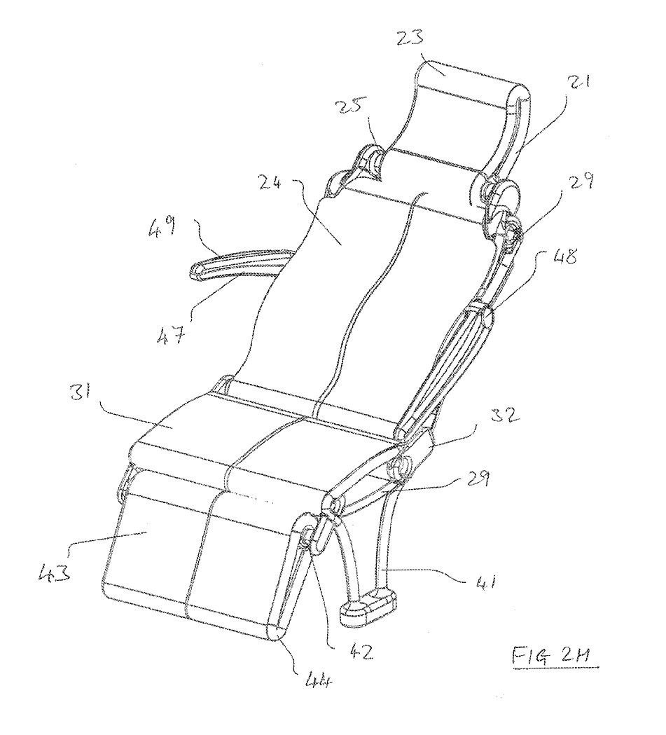

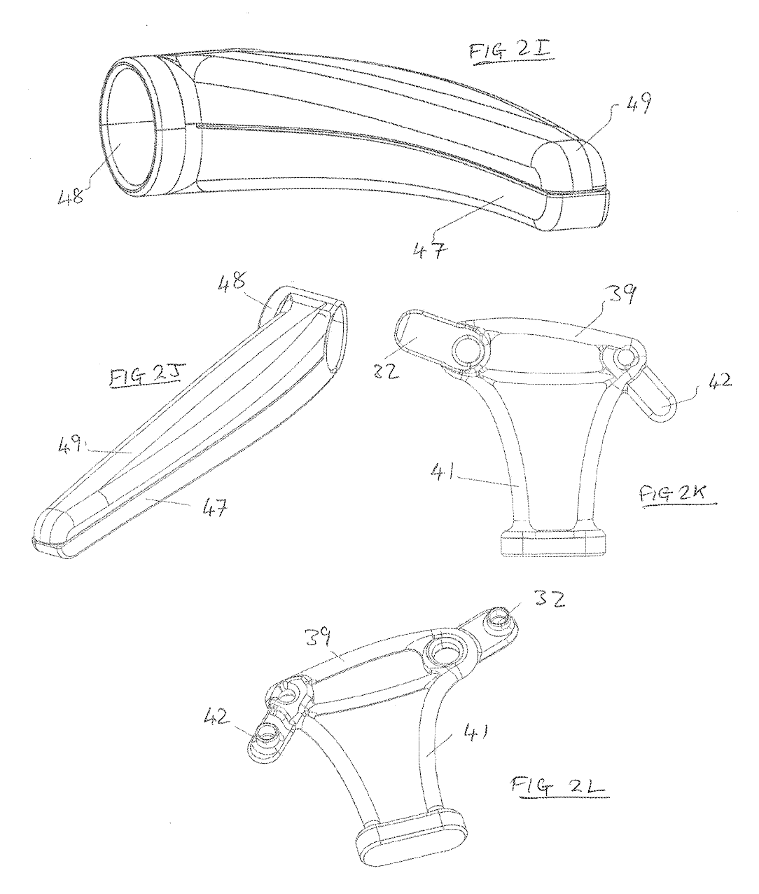

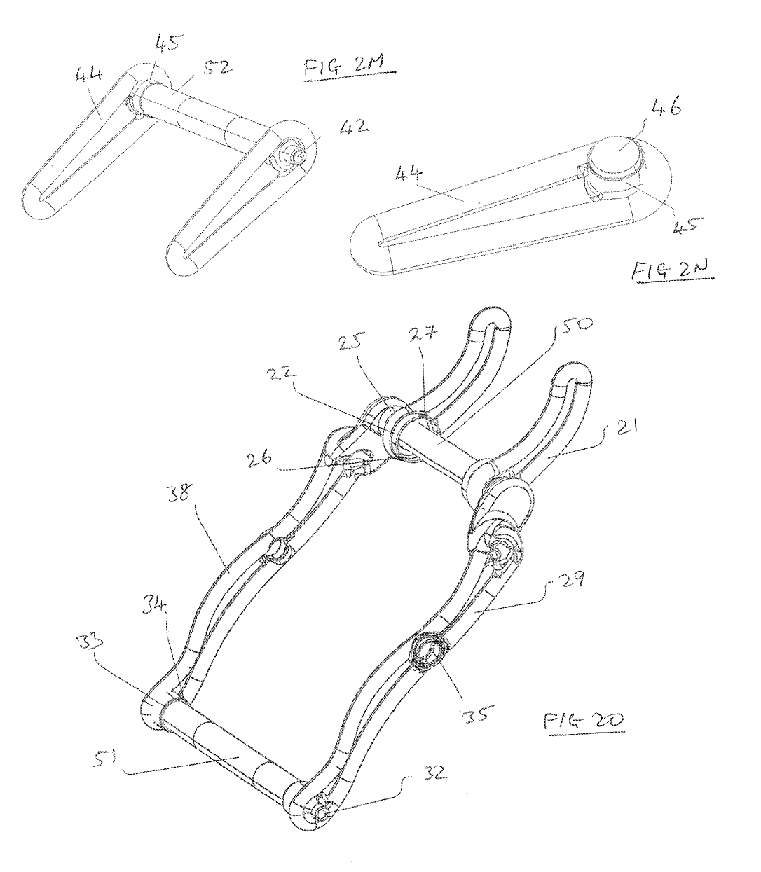

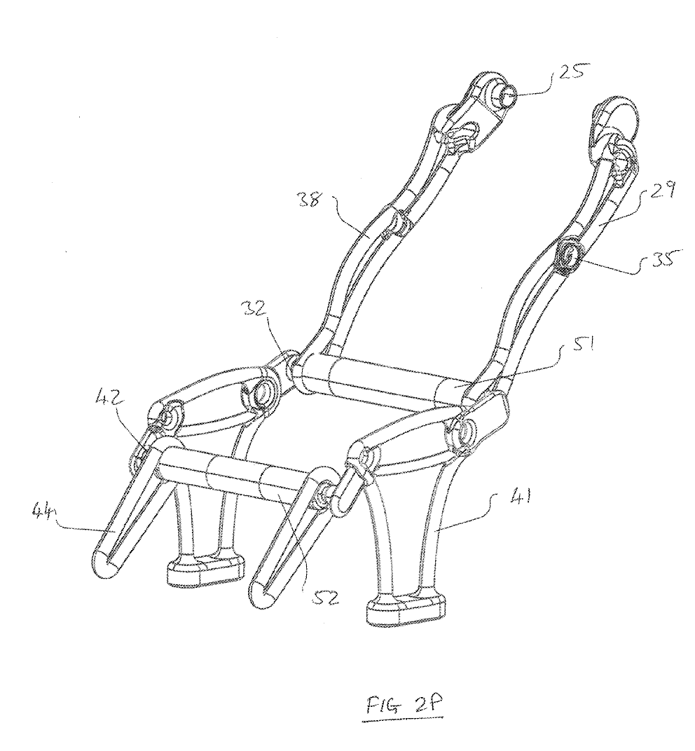

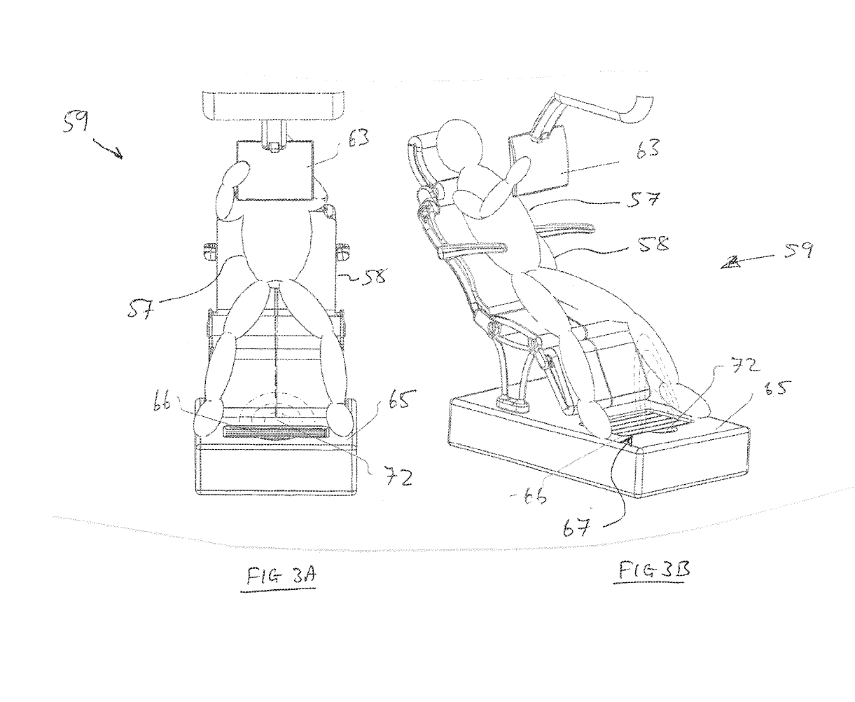

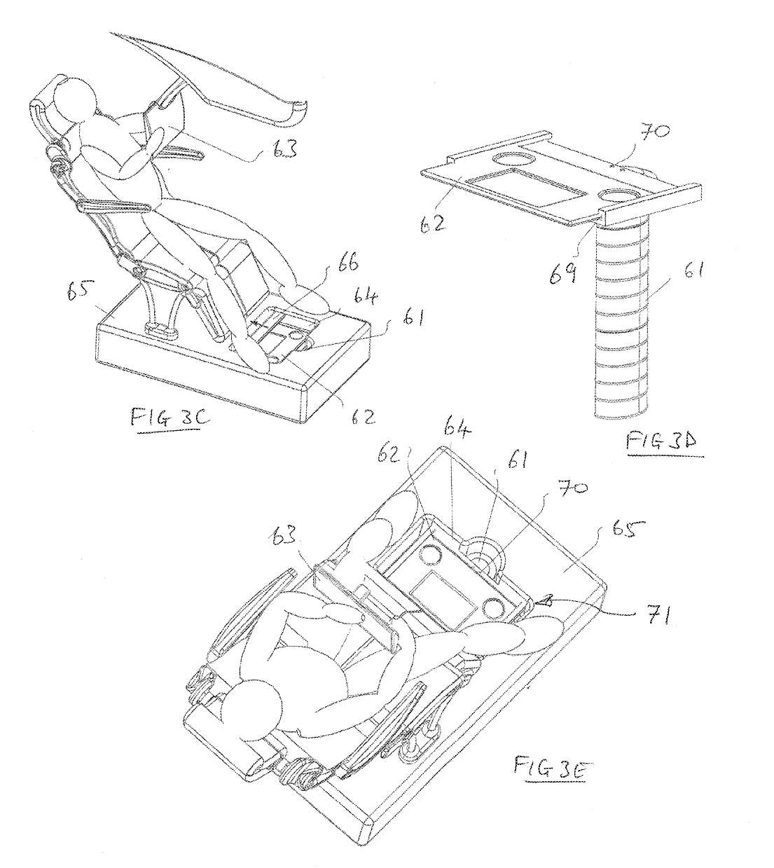

FIGS. 2A to 2P show a passenger seat assembly 19 according to one embodiment of the present invention. The passenger seat assembly 19 according to this embodiment comprises several modules including a headrest 21 pivotally mounted 25 to a backrest 29 which is again pivotally mounted 32 to a seat pedestal 21 mounted to the floor of a cabin 40. Projecting from the seat pedestal 41 is a footrest 44 which is also pivotally mounted 42.

The seat assembly 19 comprises tubular members such as that shown in FIG. 2B for the headrest. The tubular members form a peripheral frame more clearly seen in FIG. 2P where the passenger support infill has been removed for clarity.

In this arrangement, each of the modules includes a double arrangement of tubular members providing a gap between the members. This has the advantage of providing increased connectivity for the passenger support infill which may be conventional cushions or a membranous mesh. The double arrangement of tubes therefore allows added strength along the forward axis of the seat, that is, the axis parallel to the line of sight of the passenger whilst seated. Robust pivotal connections 25, 32 and 42 along with cross members 50, 51, and 52 provide resistance against warping of the frame particularly in the case of a mesh infill which will not provide structural support in the same way a cushion may do.

Looking at the individual modules, the headrest shown in FIG. 2B includes a cross member 50 acting as an axle about which the headrest may pivot relative to the backrest. The pivot includes a rotary actuator 27 to facilitate remote movement of the headrest through control by the passenger. Connection to the backrest is provided through a shared joint 25. The alternative embodiment shown in FIG. 2F of the headrest frame includes a protective barrier 28 of a soft material to prevent the passenger impacting the pivot 22 or the shared joint 25. The material 28 may be a soft elastomeric material such as silicone or a conventional air expanded polymer such as a cushion.

FIGS. 2I and 2J show various views of the armrest having again a soft material 49 for passenger comfort but comprising a fundamentally tubular structure 47 which fits into a pivotal section 36 as shown in FIGS. 2A and 2C. The arrangement allows the seat assembly to recline to an angle of up to 45°, as shown in FIG. 2C.

FIGS. 2K and 2L show the seat pedestal 41 with the pivotal connectors 32 for the backrest and 42 for the footrest. The pedestal again comprises a tubular construction 39 and may include a peripheral frame of more significant strength as compared to the frame of other parts of the passenger seat assembly given the concentration of loads required to mount the pedestal 41 to the cabin floor 40. Reference is made to the 16G specification for aircraft passenger seats. FIG. 2O shows the backrest mounted to the headrest through shared joint 25 with actuator 27 also shown. Cross members 50 and 51 providing lateral structural support for the backrest as well as an axle upon which the headrest and backrest may pivot is also shown. It will be noted that the tubular construction 38 is shaped in this embodiment to provide an ergonomic fit for the passenger in the case of a mesh being used as a passenger support infill as shown in FIG. 2H. Whilst the mesh provides a membranous tension supporting the passenger by having a preset curve to the frame 38, a better defined shaped to support the lumbar region is provide.

FIGS. 2M and 2N show the footrest frame again having a tubular construction 44 and a shared joint 42 for mounting to the seat pedestal 41. An actuator 46 is provided at least one end and possibly both ends of the cross member 52 to provide motorized remote control by the passenger.

In a further embodiment, a cover or flashing may be mounted to the cross members 50, 51 and 52 to seal off any gap between each module to prevent pinching or catching of clothing or fingers during relative movement of the passenger seat. Such flashing may be an extension of the soft material mounted to the cross members 50, 51, 52 or a separate member attached to said cross members.

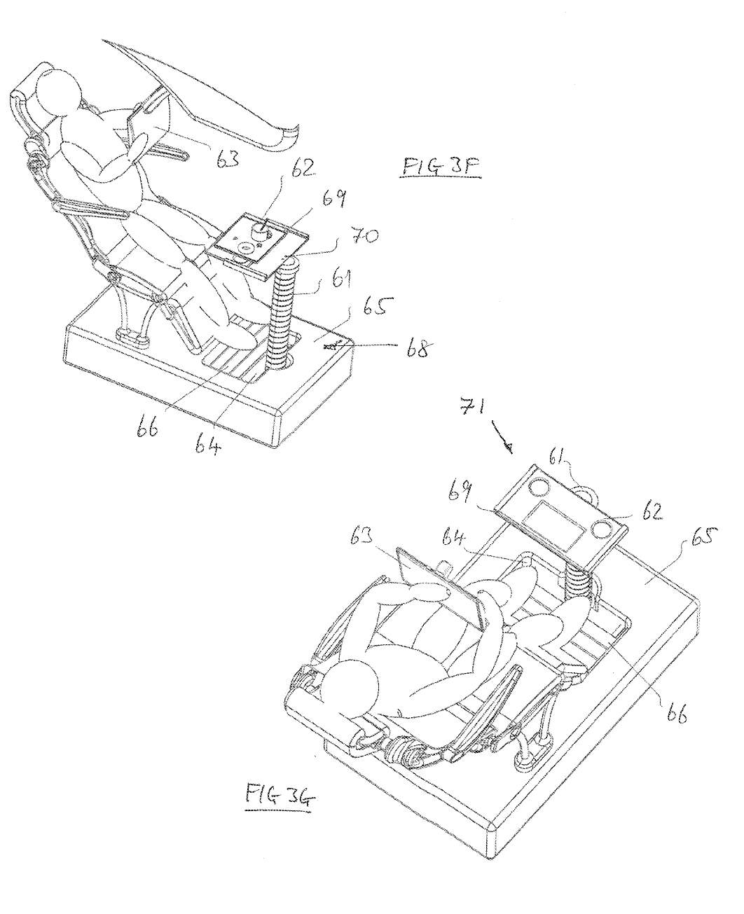

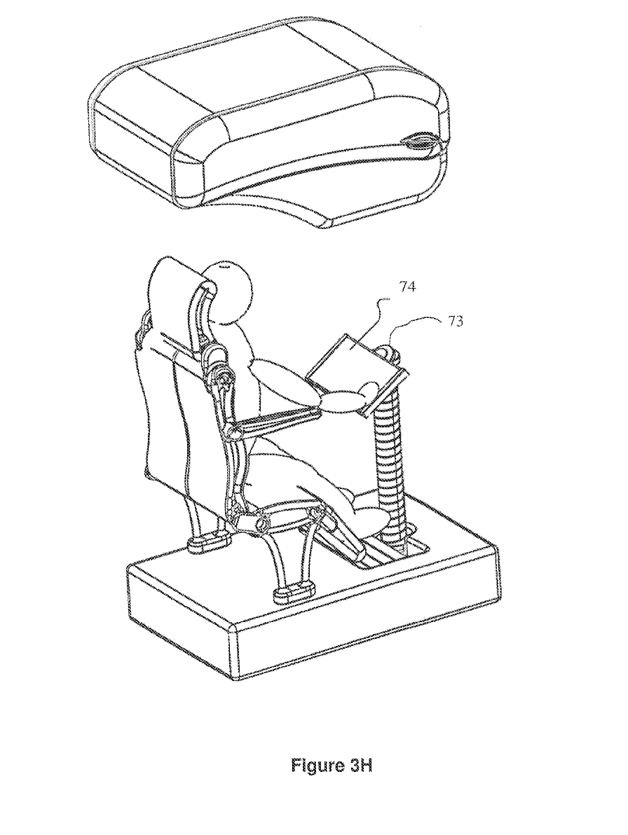

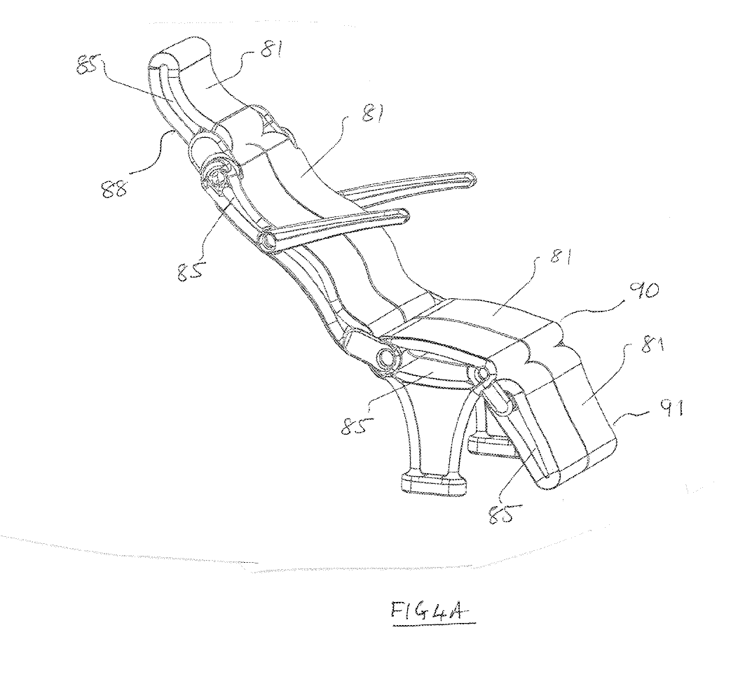

FIGS. 3A to 3G show a further embodiment of the present invention. FIGS. 3A and 3B show a passenger space 59 where a passenger 57 is seated within a passenger seat 58. In these figures, the passenger is viewing a video screen assembly 63.

In this embodiment, mounted within a cavity 67 in the cabin floor 65 is a tray 62 mounted to a support 61. This is shown more clearly in FIG. 3D.

The support 61 in this embodiment is a single column extendable from within the cavity 67 on retracting a cover 66 in the cabin floor 65. The tray assembly as shown in FIG. 3D is extendable from the floor to a set position which may be controlled through a proximity or limit switch 70 indicating the full height of the support 61 has been reached. In this embodiment, the tray 62 is mounted to the support 61 through guides 69 which permit a forward and backward sliding of the tray to allow the passenger to position the tray in the most convenient place. Please note the mounting of the tray to the support may also provide for a transverse adjustment such as for when the passenger needs to stand up. As shown in FIG. 3H, the mounting may further include a pivotal mounting 73 should the passenger wish to use the tray 74 to support work and/or provide a convenient writing surface.

When the passenger has finished using the tray, the tray may be automatically retracted within the cavity 67. As with the full extension, full retraction into the cavity by the support 61 may be determined by a further limit switch within the cavity showing the support no further retraction is required. As shown in FIGS. 3A and 3B, the sliding cover 66, or the cavity 67, protecting the tray may include a sensor such as an ultrasonic sensor 72. The sensor 72 may detect whether the passenger's feet are proximate to the cover 66 and prevent opening until the passenger splays his feet so as to allow the tray to rise.

In a further embodiment, the cavity 67 may be large enough to retain a food tray with food, so as to allow the passenger to leave his seat in the middle of the meal, without having to remove the tray of food.

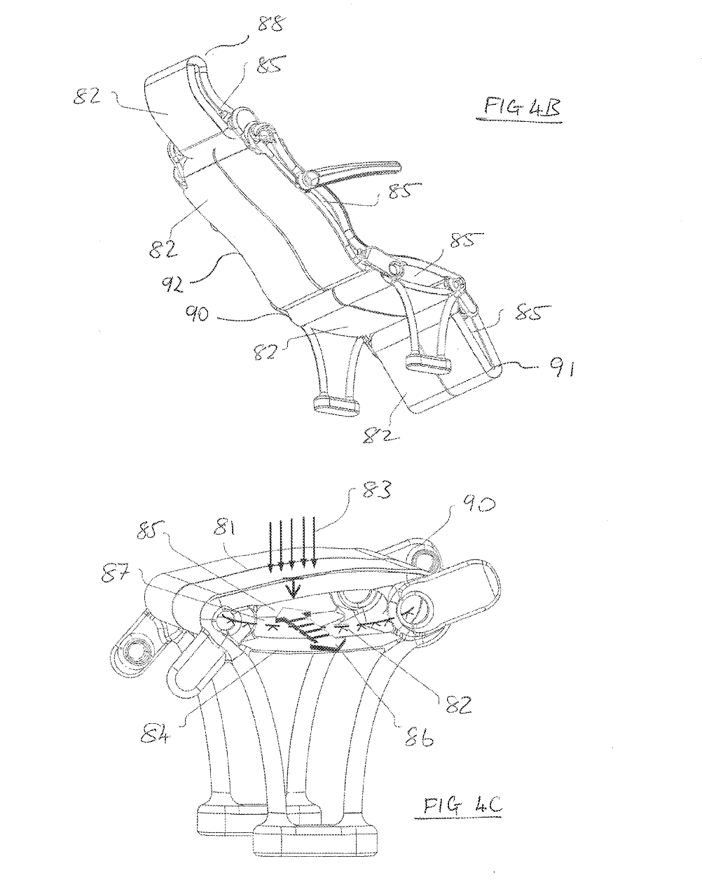

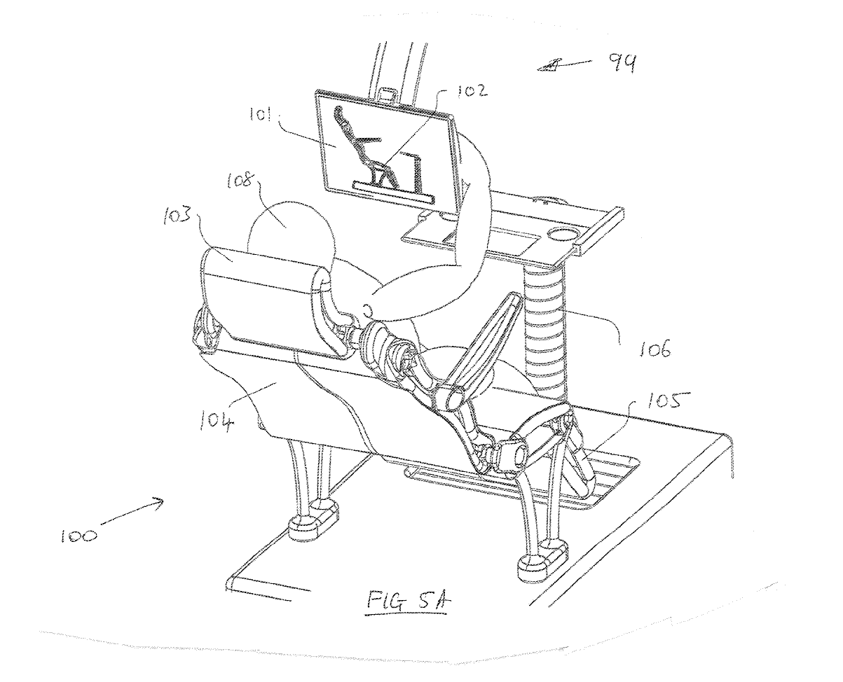

FIGS. 4A to 4C show a passenger seat assembly having a membranous mesh 81 as a passenger supporting infill.

The passenger seat assembly includes various modules to which the mesh has been mounted. It will be noted that the passenger seat assembly comprising a peripheral frame arrangement as shown in FIGS. 2A to 2P is suitable for the mesh according to this embodiment of the present invention. However, it should further be noted that the mesh according to the present invention may be applicable to other passenger seat assemblies.

As shown in FIGS. 4A and 4B there is provided a passenger support face 81 and a reaction face 82 of the mesh. A key feature of the present invention is the connection of the passenger face mesh and the reaction face mesh so as to provide load distribution between the two faces. To this end, the mounting of the mesh to the passenger seat requires a degree of slippage so as to be able to distribute the load between the passenger face and the reaction face.

The mesh may be of a range of suitable materials including polyester or a polyester acrylic mix. The mesh on the passenger face will need to meet appropriate abrasion and tensile properties. However, the mesh on the reaction face may or may not need these requirements as they do not come into contact with the passenger. To this end, the reaction mesh may or may not be of the same material as the mesh on the passenger face. The mesh on the reaction face, for instance, may include an visco-elastic material assisting in the dampening of vibration applied to the passenger seat so as to limit the transmission of the vibration to the passenger. A key component of the mesh is on application of the load 83, the load is redistributed 86 to the reaction face so as to provide a design feature to the comfort of the passenger.

In addition to the ability to provide the reaction face of a different material and so controlling issues such as dampening and vibration control, such a passenger support infill would also be easier to clean and lighter than conventional passenger support infill such as cushioning.

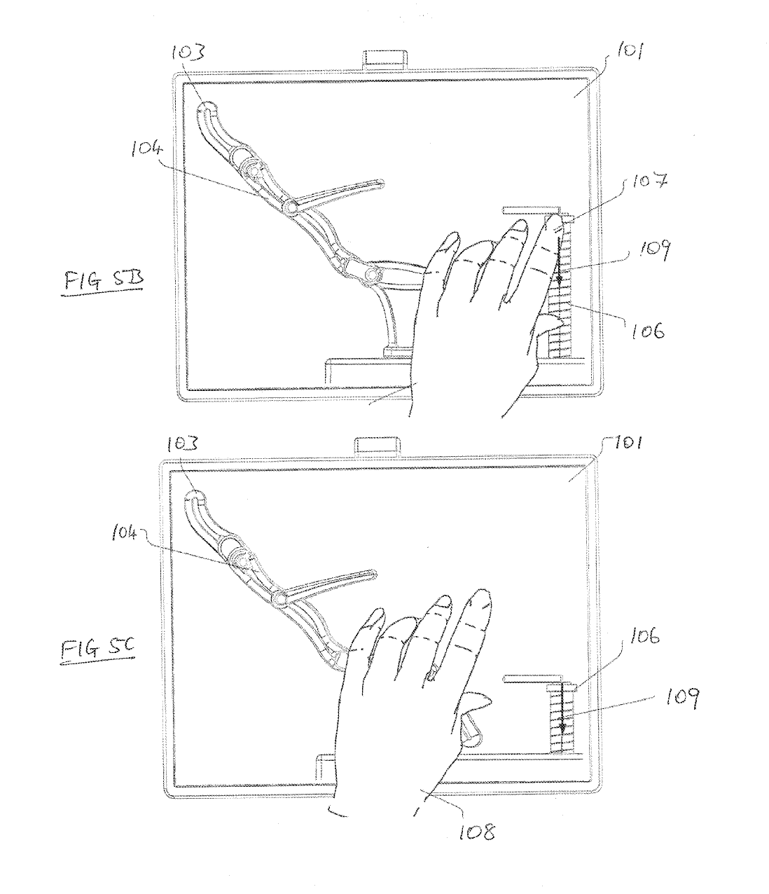

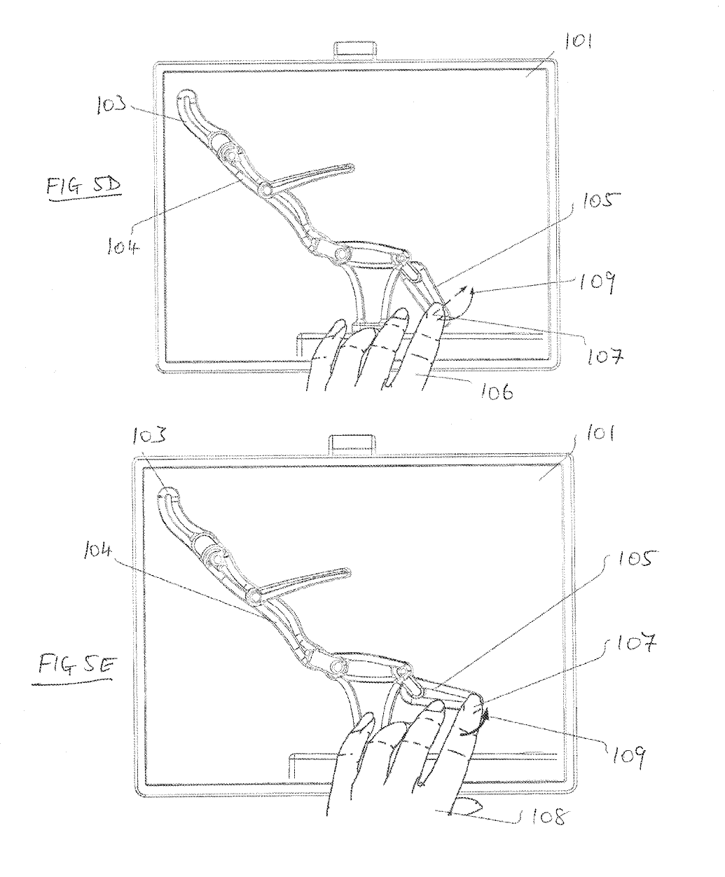

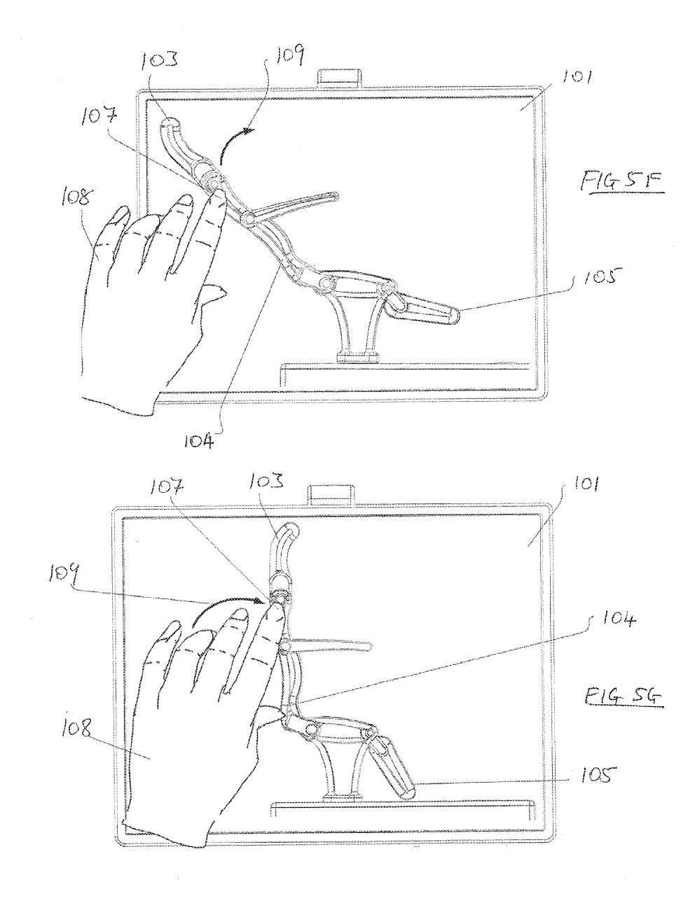

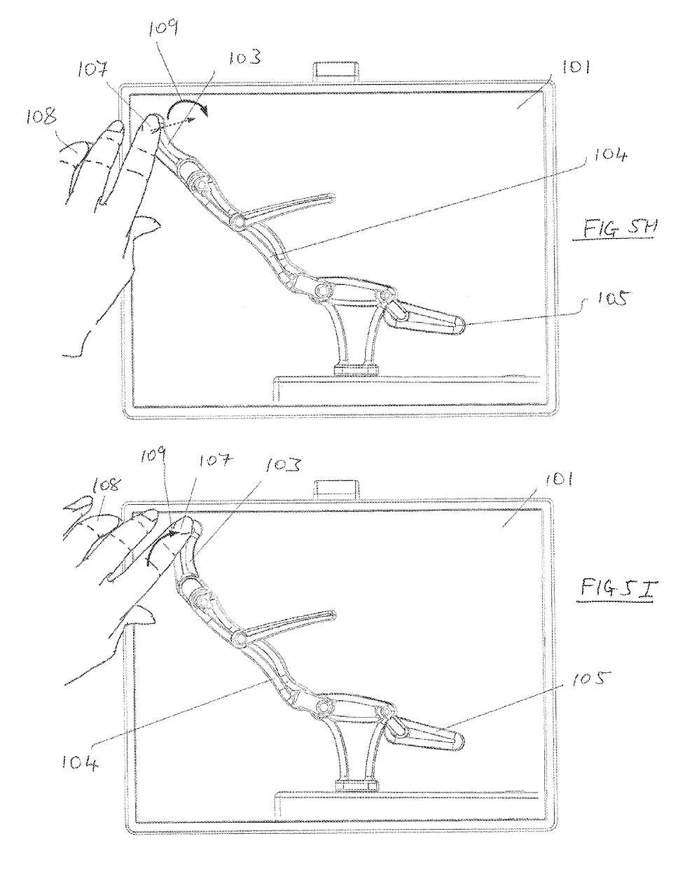

In a further embodiment of the present invention, FIG. 5A shows a passenger space 100 having a passenger seat 103, 104, 105 and a tray assembly 106 whereby a video assembly 99 provides a graphical user interface 101 displaying a graphical representation 102 of the passenger seat and tray assembly.

In this arrangement, the passenger 108 is able to control the movement of each of the modules 103, 104, 105 of the passenger seat to provide the most comfortable position through the graphical user interface 101.

FIG. 5B to 5I show various usage of the graphical user interface 101 coupled to drive systems within the passenger space 100. In FIGS. 5B and 5C, by engaging the drive systems the height of the tray assembly 106 can be raised or lowered through a touching 109 the screen of the graphical user interface 101, extending or lowering the graphical representation of the support. Similarly, in FIGS. 5D to 5I, each of the modules of the passenger seat can be moved through a touch 109 of the module on the interface 101. The drive system may include motors coupled to the various components, such as a rotary motor for the components of the passenger seat assembly (head rest, back rest, foot rest etc.) for relative movement of the components. Similarly, the articulated arm of the video screen assembly may also have a drive system coupled thereto for extending and retracting the video screen. The

In particular, in FIGS. 5D and 5E, the relative rotation of the footrest 105 can be positioned through swiping a finger 107 to the desired location. Similarly, FIG. 5F to 5I show how the position of the headrest 103 and backrest 104 can be achieved by swiping the screen 109 to reposition the graphical representation of the seat which in turn operates the motorized seat assembly to achieve the position desired.

1. A video screen assembly for a passenger seat the assembly comprising:
a ceiling mount for mounting the assembly to a ceiling of the cabin;
an articulated arm coupling a video screen to the ceiling mount;
said articulated arm arranged to retract the screen proximate to the ceiling mount and extend the screen to a viewing position;
wherein said screen is mounted to the articulated arm so as to permit rotation about at least one principle axis.

2. The video screen assembly according to claim 1, further including a selectively releasable lock arranged to lock the articulated arm in either the retracted position or viewing position.

3. The video screen assembly according to claim 1, further including a recess in the ceiling mount for receiving the video screen in the retracted position.

4. The video screen assembly according to claim 1, wherein the screen to arm mounting provides three degrees of freedom for adjustment of the video screen relative to the articulated arm.

5. The video screen assembly according to claim 1, wherein the ceiling mount includes a locker for receiving passenger luggage.

6. A passenger seat assembly comprising:
a plurality of seat modules, said seat modules comprising a headrest mounted to one end of a backrest and a seat pedestal to which the backrest is pivotally mounted, said seat pedestal mounted to a floor of the cabin;
wherein each of said modules, backrest and seat pedestal comprise a peripheral frame for receiving a passenger seat infill.

7. The passenger seat assembly according to claim 6, wherein said peripheral frame comprises an assembly of tubular members.

8. The passenger seat assembly according to claim 6, wherein each module mounting includes a rotational actuator arranged to rotate said adjacent modules relative to each other.

9. The passenger seat assembly according to claim 6, wherein said mountings include a cross member and axle collinear with said cross member, said cross member including a protective layer arranged to preventive impact injury to a passenger.

10. The passenger seat assembly according to claim 6, wherein the module mounting are arrange to recline the seat to an angle of up to 45°.

11. A food tray assembly for a passenger seat, the assembly comprising:
a tray mounted to a selectively extendable support, said support mounted to a floor of a vehicle cabin;
said selectively extendable support arranged to move the tray from a retracted position within a cavity in the floor to an extended position for use by a passenger within said passenger seat.

12. The food tray assembly according to claim 11, wherein the tray mounting includes a sliding engagement, said tray arranged to slide the tray from a proximate position to a distal position relative to the passenger seat.

13. The food tray assembly according to claim 11, wherein the support is telescopic.

14. The food tray assembly according to claim 11, further including an upper proximity switch arranged to signal the tray reaching the extended position.

15. A passenger seat assembly comprising:
an assembly of seating modules arranged for relative pivotal movement;
a membranous mesh fixed about each module for providing support to a passenger in said passenger seat assembly;
said mesh comprising a passenger support face and a reaction face on an opposed face of each of said modules;
said mesh fixed so as to permit relative movement between the passenger face and reaction face and arranged to redistribute tension between the passenger face and the reaction face.

16. The passenger seat assembly according to claim 15, wherein the mesh is fixed to a frame of said modules through an eyelet in sliding engagement with a lug coupled to said frame, said eyelet and lug providing relative movement between said frame and mesh.

17. A passenger space comprising:
a graphical user interface for receiving input from a passenger and a passenger seat assembly, said graphical user interface in communication with a drive system coupled to said seat assembly, said seat assembly having a plurality of components arranged to move relative to each other through operation of said drive system;
said graphical user interface including a touch screen for displaying a graphical representation of the components of said seat assembly, said drive system arranged to move said components in proportion to movement of the graphical representation of said component.

18. The passenger space according to claim 17, wherein said passenger input includes touching and swiping said graphical representation of the passenger seat components assembly in the desired direction.

19. The passenger space according to claim 17, wherein said passenger seat assembly comprises:
a plurality of seat modules, said seat modules comprising a headrest mounted to one end of a backrest and a seat pedestal to which the backrest is pivotally mounted, said seat pedestal mounted to a floor of the cabin;
wherein each said modules, backrest and seat pedestal comprise a peripheral frame for receiving a passenger seat infill.

20. The passenger space according to claim 17, further including a food tray assembly, comprising a tray mounted to a selectively extendable support, said support mounted to a floor of a vehicle cabin; said selectively extendable support arranged to move the tray from a retracted position within a cavity in the floor to an extended position for use by a passenger within said passenger seat, said food tray assembly in communication with said drive system for extending and retracting said tray, said screen including a graphical representation of said food tray assembly and arranged to extend or retract said food tray through touching and swiping said graphical representation of the food tray assembly in the desired direction.

21. The passenger space according to claim 17, further including a video screen tray assembly, comprising a ceiling mount for mounting the assembly to a ceiling of the cabin; an articulated arm coupling a video screen to the ceiling mount; said articulated arm arranged to retract the screen proximate to the ceiling mount and extend the screen to a viewing position; wherein said screen is mounted to the articulated arm so as to permit rotation about at least one principle axis, said video screen assembly in communication with said drive system for extending and retracting said video screen, said screen including a graphical representation of said video screen assembly and arranged to extend or retract said video screen through touching and swiping said graphical representation of the video screen assembly in the desired direction.

22. The passenger space according to claim 17, wherein the graphical user interface includes at least graphical representation of a tab, said tab arranged to operate the drive system so as to move the components of the passenger seat assembly into a pre-defined relative orientation.

23. The passenger space according to claim 22, further including a reader said reader arranged to read a graphical code presented by said passenger, said code corresponding to a set of instructions corresponding to the pre-defined relative orientation.

24. The passenger space according to claim 23, wherein said code if a bar code or a QR code.

25. The passenger space according to claim 23, wherein said code is read from a mobile device.

26. The passenger space according to claim 17, further including a sensor in communication with said drive system, said sensor arranged to detect passenger movement and instruct the video screen assembly to retract the screen on detecting the passenger commencing to stand.

27. The passenger space according to claim 26, wherein the sensor arranged to detect facial movement of the passenger and retract the video screen on detecting the passenger's eyes being closed for a pre-determined period.
